(19) United States
(12) Patent Application Publication
(10) Pub. No.: US 2023/0200383 A1
(43) Pub. Date: Jun. 29, 2023

(54) NEW TRINEXAPAC-ETHYL MICROEMULSION COMPOSITIONS

(71) Applicant: SYNGENTA CROP PROTECTION AG, Basel (CH)

(72) Inventors: Jean-Charles Daniel Nicolas BROQUET, Bracknell, Berkshire (GB); Rina SOLANKI, Bracknell, Berkshire (GB)

(73) Assignee: SYNGENTA CROP PROTECTION AG, Basel (CH)

(21) Appl. No.: 17/999,603

(22) PCT Filed: May 20, 2021
(86) PCT No.: PCT/EP2021/063557

§ 371 Date: Nov. 22, 2022

(30) Foreign Application Priority Data
May 28, 2020 (EP) 20177038.5

(51) Int. Cl. A01N 25/30; A01N 37/42; A01N 25/04; A01P 21/00

(52) U.S. Cl. CPC A01N 25/30; A01N 25/04; A01N 37/42; A01P 21/00

(57) ABSTRACT

The present invention relates to a new trinexapac-ethyl microemulsion composition. Such compositions are useful in agriculture for regulating the growth of plants.

### TECHNICAL FIELD

The present invention relates to a new trinexapac-ethyl microemulsion composition. Such compositions are useful in agriculture for regulating the growth of plants.

### BACKGROUND

Trinexapac-ethyl has the following chemical formula:

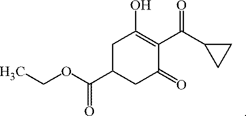

Trinexapac-ethyl is a systemic plant growth regulator and retardant, which is absorbed by foliage, translocated acropetally and basipetally in the phloem and xylem to the growing shoots. Trinexapac-ethyl reduces stem growth by inhibition of internode elongation. Trinexapac-ethyl is particularly applied in cereals such as wheat and barley.

Trinexapac-ethyl is preferably formulated as a microemulsion (ME) formulation. Microemulsions are usually diluted with a big excess of water, i.e. a so-called tank mix is prepared, before being applied by the farmer on the field. However, many microemulsions often have technical drawbacks when being diluted in tanks such as the formation of sediments or the formation of bigger oil droplets via coalescence. There is therefore a continued need to provide improved microemulsion formulations which exhibit better physical stability. Furthermore, the chemical stability of trinexapac-ethyl, i.e. the so-called shelf life, in formulations is often not as desired. It is the aim of this invention to provide a trinexapac-ethyl microemulsion without these drawbacks.

### DESCRIPTION OF THE EMBODIMENTS

Thus, in a first aspect of the invention, as embodiment 1, there is provided a microemulsion composition comprising
(i) trinexapac-ethyl, and
(ii) a poly(ethylene oxide)-poly(propylene oxide)-poly(ethylene oxide) block copolymer, wherein the average molecular weight of the poly(propylene oxide) block of the block copolymer molecule is in the range of 1450 to 3000 gram/mol, and the weight percentage of the poly(ethylene oxide) block as part of the entire block copolymer molecule is in the range of 20 and 50%.

One of the crucial properties of a formulation such as the composition according to embodiment 1 is its long term stability. The temperatures during transportation of said formulations may vary dramatically, e.g. from -20° C. to 50° C. Any form of instability within the formulation may have a severe impact on the active ingredient present in the formulation and the applications and treatments possible. It has been found that surprisingly only combinations of trinexapac-ethyl with very specific surfactants can form a physically and chemically stable trinexapac-ethyl microemulsion with acceptable water dilution properties.

The stability of concentrated microemulsions upon dilution with water is of particular importance as such concentrates are first diluted with many times the amount of water before use. It has been surprisingly found that microemulsions according to embodiment 1 retain their properties as microemulsions even upon dilution with many times the amount of water which is not the case for microemulsions with other types of surfactants.

As embodiment 2, there is provided a microemulsion composition according to embodiment 1 wherein the average molecular weight of the poly(propylene oxide) block of the block copolymer molecule is in the range of 1700 to 2800 gram/mol, and the weight percentage of the poly(ethylene oxide) block as part of the entire block copolymer molecule is in the range of 30 and 45%.

As embodiment 3, there is provided a microemulsion composition according to embodiment 1 or 2 wherein the average molecular weight of the poly(propylene oxide) block of the block copolymer molecule is in the range of 2000 to 2800 gram/mol, and the weight percentage of the poly(ethylene oxide) block as part of the entire block copolymer molecule is in the range of 35 and 45%.

As embodiment 4, there is provided a microemulsion composition according to any one of embodiments 1 to 3 wherein the concentration of the poly(ethylene oxide)-poly(propylene oxide)-poly(ethylene oxide) block copolymer in the microemulsion composition is between 50 and 125 gram/liter.

As embodiment 5, there is provided a microemulsion composition according to any one of embodiments 1 to 4 wherein the concentration of the poly(ethylene oxide)-poly(propylene oxide)-poly(ethylene oxide) block copolymer is between 75 and 100 gram/liter.

As embodiment 6, there is provided a microemulsion composition according to any one of embodiments 1 to 5 wherein the concentration of trinexapac-ethyl is between 200 and 400 gram/liter.

As embodiment 7, there is provided a microemulsion composition according to any one of embodiments 1 to 6, wherein the concentration of trinexapac-ethyl is between 225 and 300 gram/liter.

As embodiment 8, there is provided a microemulsion composition according to any one of embodiments 1 to 7, wherein the composition further comprises surfactants selected from castor oil alkoxylates.

In particular, as embodiment 9, there is provided a microemulsion composition according to any one of embodiments 1 to 8 wherein the composition further comprises 400 to 600 gram/liter of a water-miscible solvent.

In particular, as embodiment 10, there is provided a microemulsion composition according to any one of embodiments 1 to 9 wherein the water-miscible solvent is selected from an amyl alcohol, or a mixture thereof. As used herein, an “amyl alcohol” is any of 8 alcohols with the formula C5H12O. A suitable product is sold under the tradename PENTANOL 45®.

Block copolymers of ethylene oxide and propylene oxide can be di- and tri-block copolymers, such as ABA or BAB block copolymer or BA block copolymers. Examples include the GENAPOL® PF series (CLARIANT), the PLURONIC® series (BASF), the SYNPERONIC® PE series (CRODA), or the TOXIMUL® series (STEPAN). The group of ethylene oxide/propylene oxide block copolymers for use in the microemulsion compositions of embodiment 1 are poly(ethylene oxide)-poly(propylene oxide)-poly(ethylene oxide) block copolymer with an average molecular weight of the poly(propylene oxide) block in the range of 1450 to 3000 gram/mol, and the weight percentage of the poly(ethylene oxide) block as part of the entire block copolymer molecule is in the range of 20 and 50%. Preferred block copolymers are tri-block copolymers with ABA. Examples suitable for use in a microemulsion according to embodiment 1 include but are not limited to the products sold under the tradenames Pluronic® PE6200, Pluronic® PE6400, Pluronic® P84 and Pluronic® PE9400.

A skilled person is aware that Pluronic® poly(ethylene oxide)-poly(propylene oxide)-poly(ethylene oxide) block copolymers are characterized by the average molecular weight of the poly(propylene oxide) block of the block copolymer molecule and the percentage of poly(ethylene oxide) block of the entire copolymer in the so-called “Pluronic grid” (P. Bahadur and G. Riess, Tenside Surf. Det., 28, 1991, 173). The Pluronic grid ranges from 950 to 4000 gram/mol average molecular weight of the poly(propylene oxide) block and from 10 to 80% weight percentage of the poly(ethylene oxide) block. As mentioned above, it has surprisingly found that only a very small selection of poly(ethylene oxide)-poly(propylene oxide)-poly(ethylene oxide) block copolymers can provide a physically and chemically stable microemulsion formulation of trinexapac-ethyl.

As embodiment 11, there is provided a microemulsion composition according to any one of embodiments 1 to 10, further comprising an alkylbenzene sulfonate. In particular, as embodiment 12, there is provided a microemulsion composition according to embodiment 11, wherein the alkylbenzene sulfonate is a dodecyl-benzene sulfonate, more particularly a calcium dodecyl-benzene sulfonate. As embodiment 13, the microemulsion composition comprises from 5 to 15 gram/liter alkylbenzene sulfonate. A suitable product is sold under the tradename PHENYLSULFONATE 2842®.

As embodiment 14, there is provided a microemulsion composition according to any one of embodiments 1 to 13, further comprising an antifoam emulsion, in particular a silicon antifoam emulsion. As embodiment 15, the microemulsion composition comprises from 5 to 15 gram/liter of an antifoam emulsion. A suitable product is sold under the tradename SAG 1572®.

The microemulsion compositions according to any one of embodiment 1 to 15 are useful in regulating the growth of plants which comprises applying to a plant, a composition according to any one of embodiments 1 to 15. In particular, the microemulsion compositions of the invention are suitable in regulating the growth of cereal plants, in particular wheat and barley.

### Experimental

Comparison of different types of surfactants as emulsifiers in trinexapac-ethyl microemulsions:

I

The composition of the formulations tested:

| | |
|---|---|
| Component | gram / liter |
| Trinexapac-ethyl | 250 |
| Emulsifier E1* | 80 |
| Condensation product of castor oil and ethylene oxide | 10 |
| Dodecyl-benzene sulfonic acid calcium salt linear | 10 |
| Antifoam | 0.1 |
| Water | 75 |
| Pentanol mixture of isomers | Up to 1 liter |
| TOTAL | 1 liter |

*A wide variation of surfactants was tested for technical suitability (see under point (ii)).

II

Results of the testing of the formulations according to (i) where E1 refers to the emulsifier E1 in (i):

| Number | Emulsifier chemistry of emulsifier E1 [tradename] | Miscibility of emulsifier in formulation | Appearance of ME** | Appearance of 1% dilution after 24 hours at 30° C. |
|---|---|---|---|---|
| 1 | propylene-oxide/ethyleneoxide block copolymer (40% PEO, 3250 gram/mol PPO) [Pluronic PE10400®] | Yes | Yellow, transparent -slightly turbid | Turbid, yellowy beige sediment |
| 2 | propylene-oxide/ethyleneoxide block copolymer (20% PEO, 1750 gram/mol PPO) | Yes | Yellow, transparent -slightly turbid | opaque |
| 3 | propylene-oxide / ethylene oxide block copolymer (50% PEO, 2250 gram/mol PPO) [Pluronic P85®] | Yes | Slightly turbid | Opaque, trace beige sediment |
| 4 | alcohol ethoxylate, C12-C15 [Atlox 4894®] | Yes | Amber, cloudy | Opaque, beige sediment |
| 5 | polyoxyethylene (20) sorbitan trioleate [Tween 85®] | Yes | Amber, cloudy | Yellowy sediment |
| 6 | acrylic graft copolymer solution in water/propylene glycol [Tersperse 2500®] | Yes | Opaque, beige emulsion | Yellowy sediment |
| 7 | Polyalkylene oxide block copolymer [Atlas G5000D®] | Yes | Amber, slightly turbid | Large amount of oil + yellowy sediment |
| 8 | propylene-oxide / ethylene oxide block copolymer (50% PEO, 3250 gram/mol PPO) [Pluronic PE10500®] | Yes | Amber, slightly turbid | Turbid emulsion with beige sediment |
| 9 | ethylene oxide-propylene oxide triblock copolymer, reversed (25% PEO) [Pluronic RPE2525®] | Yes | Slightly turbid | Yellow oil at bottom |
| 10 | propylene-oxide / ethylene oxide block copolymer (40% PEO, 1750 gram/mo PPO) [Pluronic PE6400®] | Yes | Slightly turbid | Opaque emulsion |
| 11 | propylene-oxide / ethylene oxide block copolymer (20% PEO, 2750 gram/mol PPO) [Pluronic PE9200®] | Yes | Slightly turbid | Trace yellow sediment |
| 12 | condensate of polyoxyethylene-polyoxypropylene block on ethylenediamine [Tetronic 1107®] | Yes | Yellow, transparent -slightly turbid | Beige sediment |
| 13 | condensate of polyoxyethylene-polyoxypropylene block on ethylenediamine [Tetronic 904®] | Yes | Yellow, transparent -slightly turbid; appearance of white sediment | Opaque emulsion |
| 14 | condensate of polyoxyethylene-polyoxypropylene block on ethylenediamine [Tetronic 1301®] | Yes | Yellow, transparent -slightly turbid; appearance of white sediment | NT |
| 15 | condensate of polyoxyethylene-polyoxypropylene block on ethylenediamine [Tetronic 1304®] | Yes | Cloudy yellow/amber solution; appearance of white sediment | NT |
| 16 | condensate of polyoxyethylene-polyoxypropylene block on ethylenediamine [Tetronic 704®] | Yes | Cloudy yellow/amber solution; appearance of white sediment | NT |
| 17 | propylene-oxide / ethylene oxide block copolymer (30% PEO, 1200 gram/mol PPO) [Pluronic L43®] | Yes | With water precipitate formed | Sediment |
| 18 | propylene-oxide / ethylene oxide block copolymer (40% PEO, 2250 gram/mol PPO) [Pluronic P84®] | Yes | Clear yellow/ amber solution | Opaque emulsion |
| 19 | Iso-tridecyl alchol polyglycol ether (8 EO) [Genapol X-080®] | No | Slightly turbid -immiscible in ME | Beige sediment |
| 20 | Iso-tridecyl alchol polyglycol ether (6 EO) [Genapol X-060®] | Yes | Yellow, transparent -slightly turbid | Yellow sediment |
| 21 | Oleyl alcohol polyglycol ether (10 EO) [Genapol O-100®] | No | Transparent with immiscible water droplets | N/a |
| 22 | Oleic alcohol polyethylene glycol ether (8 EO) [Genapol O-080®] | No | Cloudy, immiscible in ME | N/a |
| 23 | Iso-tridecylalcohol polyglycol ether (5 EO) [Genapol X-050®] | No | Cloudy, immiscible in ME, | N/a |
| 24 | C12/C18 saturated fatty alcohol ethoxylate (10 EO) [Genapol C-100®] | Yes | Yellow, transparent | Oil + sediment in SHW D |
| 25 | \propylene-oxide / ethylene oxide block copolymer (40% PEO, 2750 gram/mol PPO) [Pluronic PE9400®] | Yes | Transparent, amber solution | Opalescent solution with trace cream |

NT = not tested
N/a = not applicable

The shaded formulations represent emulsifier chemistries within the scope of the invention.

One can see that surprisingly only very specific types of emulsifiers are suitable to provide microemulsion compositions which are technically suitable for real-life applications. In particular, some emulsifiers proved to be immiscible with the microemulsions. For example, from the GENAPOL® series, only Genapol C-100® was miscible (formulation 24). However, Genapol C-100® exhibited sedimentation upon dilution with water. Also emulsifiers from the TETRONIC® series proved unacceptable.

### (III) Chemical Stability of the Active Ingredient Trinexapac-Ethyl

The chemical stability of trinexapac-ethyl in microemulsion compositions having different emulsifiers E1 was tested over 12 weeks at temperatures -18 and 40° C. The following emulsifiers E1 were used in formulations according to (i) (except that no antifoam was used for some of them) for chemical stability:
a) Propylene-oxide/ethylene-oxide block copolymer (20% PEO, 1750 gram/mol PPO) [Pluronic PE6200®];
b) Propylene-oxide/ethylene-oxide block copolymer (40% PEO, 1750 gram/mol PPO) [Synperonic PE/L64®];
c) Propylene-oxide / ethylene oxide block copolymer (40% PEO, 2250 gram/mol PPO) [Pluronic P84®]
d) Propylene-oxide / ethylene oxide block copolymer (40% PEO, 2750 gram/mol PPO) [Pluronic PE9400®]

| Formulation | Percentage of trinexapac-ethyl loss after 12 weeks at 40° C. vs. -18° C. |
|---|---|
| according to (i) (except that no antifoam was used) with emulsifier a) | 7.6% |
| according to (i) (except that no antifoam was used) with emulsifier b) | 7.1% |
| according to (i) (except that no antifoam was used) with emulsifier c) | 4.0% |
| according to (i) with emulsifier c) | 4.6% |
| according to (i) with emulsifier d) | 4.8% |

Only the formulations with emulsifier c) and d) exhibited an acceptable chemical stability profile. This means that only formulations using emulsifiers c) and d) provide an acceptable shelf life for a commercial formulation.

1. A microemulsion composition comprising
(i) trinexapac-ethyl, and
(ii) a poly(ethylene oxide)-poly(propylene oxide)-poly(ethylene oxide) block copolymer, wherein the average molecular weight of the poly(propylene oxide) block of the block copolymer molecule is in the range of 1450 to 3000 gram/mol, and the weight percentage of the poly(ethylene oxide) block as part of the entire block copolymer molecule is in the range of 20 and 50%.

2. The microemulsion composition according to claim 1, wherein the average molecular weight of the poly(propylene oxide) block of the block copolymer molecule is in the range of 1700 to 2800 gram/mol, and the weight percentage of the poly(ethylene oxide) block as part of the entire block copolymer molecule is in the range of 30 and 45%.

3. The microemulsion composition according to claim 1, wherein the average molecular weight of the poly(propylene oxide) block of the block copolymer molecule is in the range of 2000 to 2800 gram/mol, and the weight percentage of the poly(ethylene oxide) block as part of the entire block copolymer molecule is in the range of 35 and 45%.

4. The microemulsion composition according to claim 1, wherein
the concentration of the poly(ethylene oxide)-poly(propylene oxide)-poly(ethylene oxide) block copolymer in the emulsion composition is between 50 and 125 gram/liter.

5. The microemulsion composition according to claim 4, wherein
the concentration of the poly(ethylene oxide)-poly(propylene oxide)-poly(ethylene oxide) block copolymer is between 75 and 100 gram/liter.

6. The microemulsion composition according to claim 1, wherein
the concentration of trinexapac-ethyl is between 200 and 400 gram/liter.

7. The microemulsion composition according to claim 6, wherein
the concentration of trinexapac-ethyl is between 225 and 300 gram/liter.

8. The microemulsion composition according to claim 1, wherein the composition further comprises surfactants selected from castor oil alkoxylates.

9. The microemulsion composition according to claim 1, wherein the composition further comprises 400 to 600 gram/liter of a water-miscible solvent.

10. The microemulsion composition according to claim 9, wherein the water-miscible solvent is selected from an amyl alcohol, or a mixture thereof.

11. A method of regulating the growth of plants which comprises applying to a plant a composition according to claim 1.

12. The method according to claim 11, wherein the plant is selected from cereals.

13. The method according to claim 11, wherein the plant is wheat or barley.
